(19) United States
(12) Patent Application Publication
(10) Pub. No.: US 2024/0242541 A1
(43) Pub. Date: Jul. 18, 2024

(54) EYEWEAR PROCESSING SIGN LANGUAGE TO ISSUE COMMANDS

(71) Applicants: Zsófia Jáger, Gárdony (HU); Anoosh Kruba Chandar Mahalingam, Sunnyvale, CA (US); Jennica Pounds, Cape Coral, FL (US); Jerry Jesada Pua, Budapest (HU)

(72) Inventors: Zsófia Jáger, Gárdony (HU); Anoosh Kruba Chandar Mahalingam, Sunnyvale, CA (US); Jennica Pounds, Cape Coral, FL (US); Jerry Jesada Pua, Budapest (HU)

(21) Appl. No.: 18/096,919

(22) Filed: Jan. 13, 2023

(51) Int. Cl. G06V 40/20; G06F 40/274

(52) U.S. Cl. CPC G06V 40/28; G06F 40/274

(57) ABSTRACT

Eyewear that identifies a hand gesture presenting sign language and then initiates a command indicative of the identified hand gesture. The eyewear uses a convolutional neural network (CNN) to identify the hand gesture by matching a hand motion to a set of hand gestures. The set of hand gestures is a library of hand gestures stored in a memory. The hand gestures can include static hand gestures, moving hand gestures, or both static and moving hand gestures. The eyewear identifies a command corresponding to a hand gesture or a series of hand gestures.

### TECHNICAL FIELD

The present subject matter relates to an eyewear device, e.g., smart glasses.

### BACKGROUND

Eyewear devices, such as smart glasses, headwear, and headgear available today integrate cameras and see-through displays.

### BRIEF DESCRIPTION OF THE DRAWINGS

The drawing figures depict one or more implementations, by way of example only, not by way of limitations. In the figures, like reference numerals refer to the same or similar elements.

FIG. 1A is a side view of an example hardware configuration of an eyewear device, which shows an optical assembly with an image display, and field of view adjustments are applied to a user interface presented on the image display based on detected head or eye movement by a user;

FIG. 1B is a top cross-sectional view of a temple of the eyewear device of FIG. 1A depicting a visible light camera, a head movement tracker for tracking the head movement of the user of the eyewear device, and a circuit board;

FIG. 2A is a rear view of an example hardware configuration of an eyewear device, which includes an eye scanner on a frame, for use in a system for identifying a user of the eyewear device;

FIG. 2B is a rear view of an example hardware configuration of another eyewear device, which includes an eye scanner on a temple, for use in a system for identifying a user of the eyewear device;

FIGS. 2C and 2D are rear views of example hardware configurations of the eyewear device, including two different types of image displays.

FIG. 3 shows a rear perspective view of the eyewear device of FIG. 2A depicting an infrared emitter, an infrared camera, a frame front, a frame back, and a circuit board;

FIG. 4 is a cross-sectional view taken through the infrared emitter and the frame of the eyewear device of FIG. 3;

FIG. 5 is an illustration depicting detection of eye gaze direction;

FIG. 6 is an illustrations depicting detection of eye position;

FIG. 7 is an illustration depicting an example of visible light captured by the visible light cameras as raw images;

FIG. 8A is an illustration depicting the camera-based compensation system that identifies objects in an image, such as a cowboy, converts identified objects to text, and then converts the text to audio that is indicative of the identified objects in the image;

FIG. 8B is an image, such as a restaurant menu, with sections that can be instructed via speech to be processed and read aloud to a user;

FIG. 8C is an illustration depicting eyewear providing diarization;

FIG. 8D is an illustration depicting translating sign language to speech;

FIG. 8E is an illustration depicting a set of sign language gestures;

FIG. 8F is an illustration depicting translating sign language gestures to text for a smart command;

FIG. 9 is a block diagram of electronic components of the eyewear device;

FIG. 10 is a flowchart of the operation of the eyewear device;

FIG. 11 is a flowchart illustrating the speech to text algorithm;

FIG. 12 is a flowchart of an algorithm translating a hand gesture presenting sign language to speech; and

FIG. 13 is a flowchart illustrating initiating a smart command using sign language.

### DETAILED DESCRIPTION

Eyewear identifies a detected hand motion presenting sign language and then initiates a command indicative of the identified hand gesture. The eyewear uses a convolutional neural network (CNN) to identify the hand gesture by matching the detected hand motion to a set of hand gestures. The set of hand gestures is a library of hand gestures stored in a memory. The hand gestures can include static hand gestures, moving hand gestures, or both static and moving hand gestures. The eyewear identifies a command corresponding to a hand gesture or a series of hand gestures.

Additional objects, advantages and novel features of the examples will be set forth in part in the description which follows, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

The term “coupled” as used herein refers to any logical, optical, physical or electrical connection, link or the like by which signals or light produced or supplied by one system element are imparted to another coupled element. Unless described otherwise, coupled elements or devices are not necessarily directly connected to one another and may be separated by intermediate components, elements or communication media that may modify, manipulate or carry the light or signals.

The orientations of the eyewear device, associated components and any complete devices incorporating an eye scanner and camera such as shown in any of the drawings, are given by way of example only, for illustration and discussion purposes. In operation for a particular variable optical processing application, the eyewear device may be oriented in any other direction suitable to the particular application of the eyewear device, for example up, down, sideways, or any other orientation. Also, to the extent used herein, any directional term, such as front, rear, inwards, outwards, towards, left, right, lateral, longitudinal, up, down, upper, lower, top, bottom and side, are used by way of example only, and are not limiting as to direction or orientation of any optic or component of an optic constructed as otherwise described herein.

Reference now is made in detail to the examples illustrated in the accompanying drawings and discussed below.

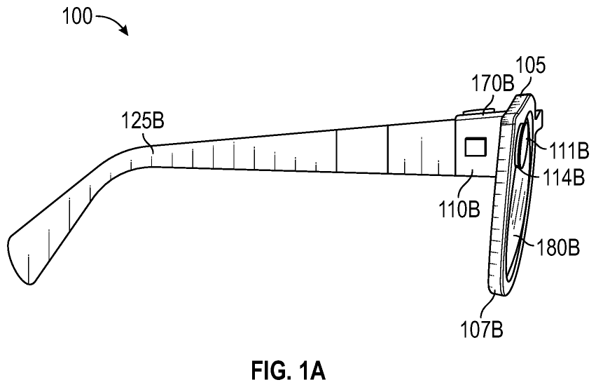

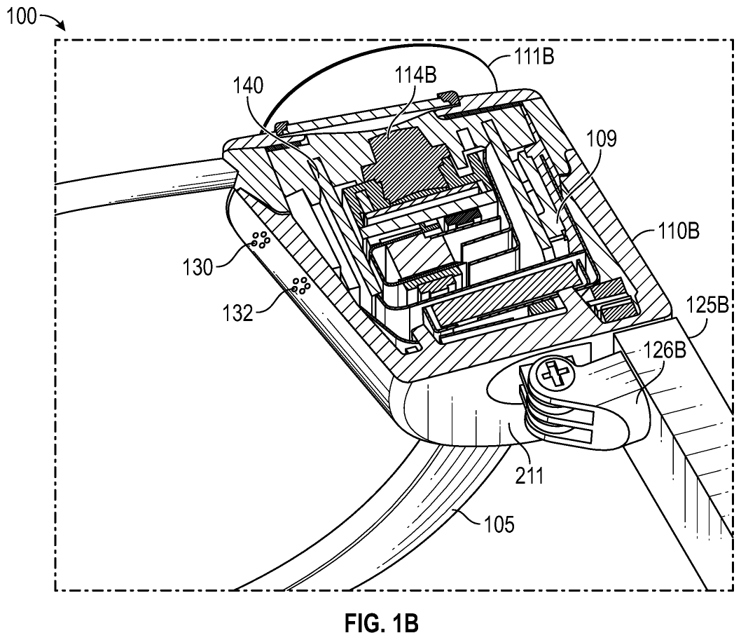

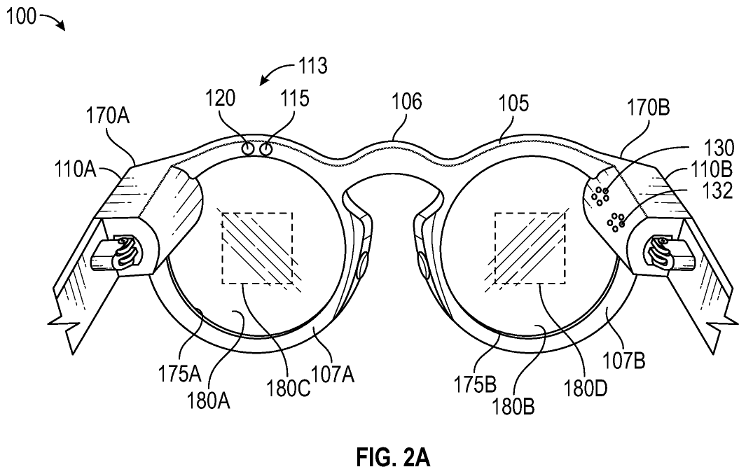

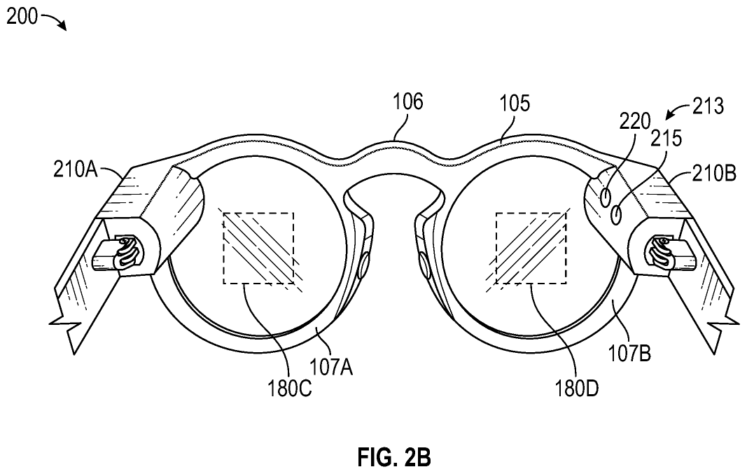

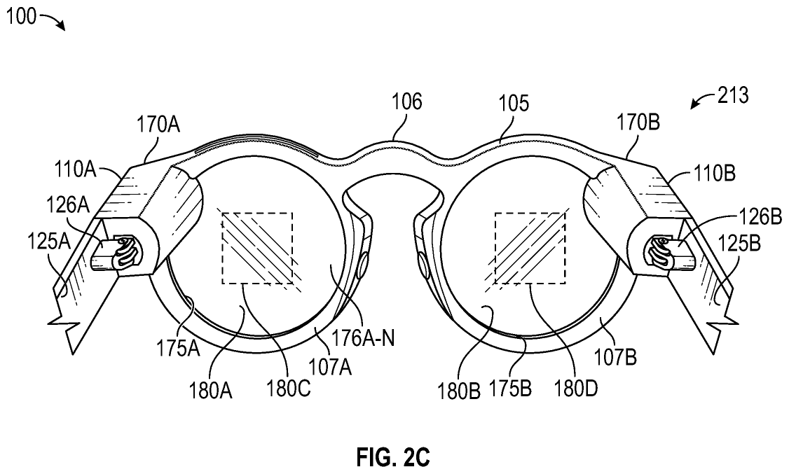

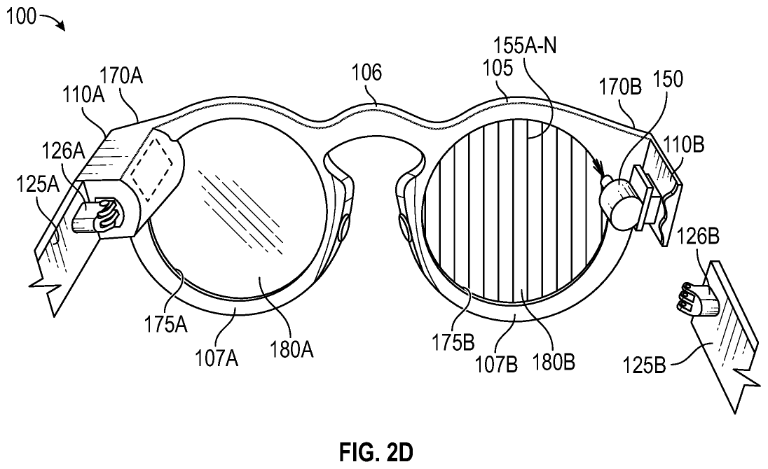

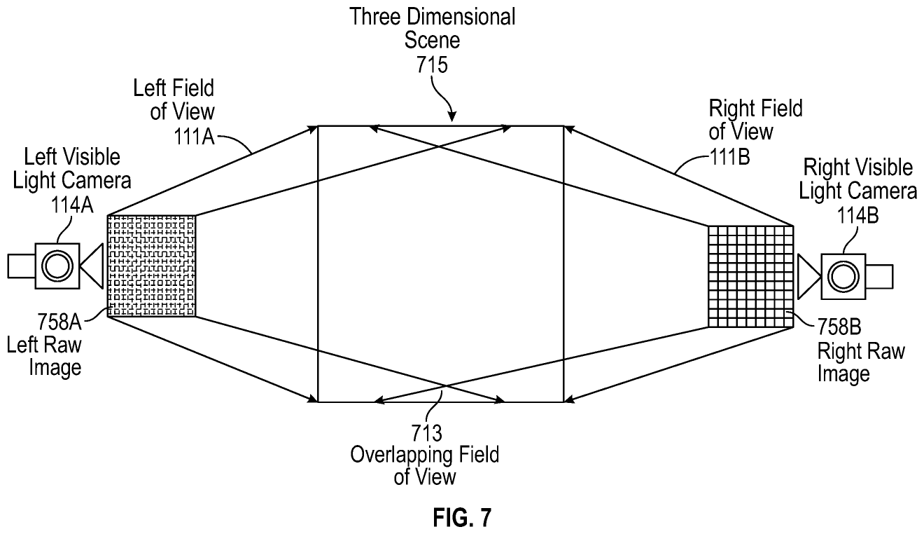

FIG. 1A is a side view of an example hardware configuration of an eyewear device 100, which includes an optical assembly 180B (e.g., positioned on a right side of the eyewear device 100 as illustrated) with an image display 180D (FIG. 2A). Eyewear device 100 includes multiple visible light cameras 114A-B (FIG. 7) that form a stereo camera, of which the visible light camera 114B is located on a temple portion 110B.

The visible light cameras 114A-B (e.g., positioned on the left and sides of the eyewear device 100 as illustrated) have an image sensor that is sensitive to the visible light range wavelength. Each of the visible light cameras 114A-B have a different frontward facing angle of coverage, for example, visible light camera 114B has the depicted angle of coverage 111B. The angle of coverage is an angle range which the image sensor of the visible light camera 114A-B picks up electromagnetic radiation and generates images. Examples of such visible lights camera 114A-B include a high-resolution complementary metal-oxide-semiconductor (CMOS) image sensor and a video graphic array (VGA) camera, such as 640p (e.g., 640×480 pixels for a total of 0.3 megapixels), 720p, or 1080p. Image sensor data from the visible light cameras 114A-B are captured along with geolocation data, digitized by an image processor, and stored in a memory.

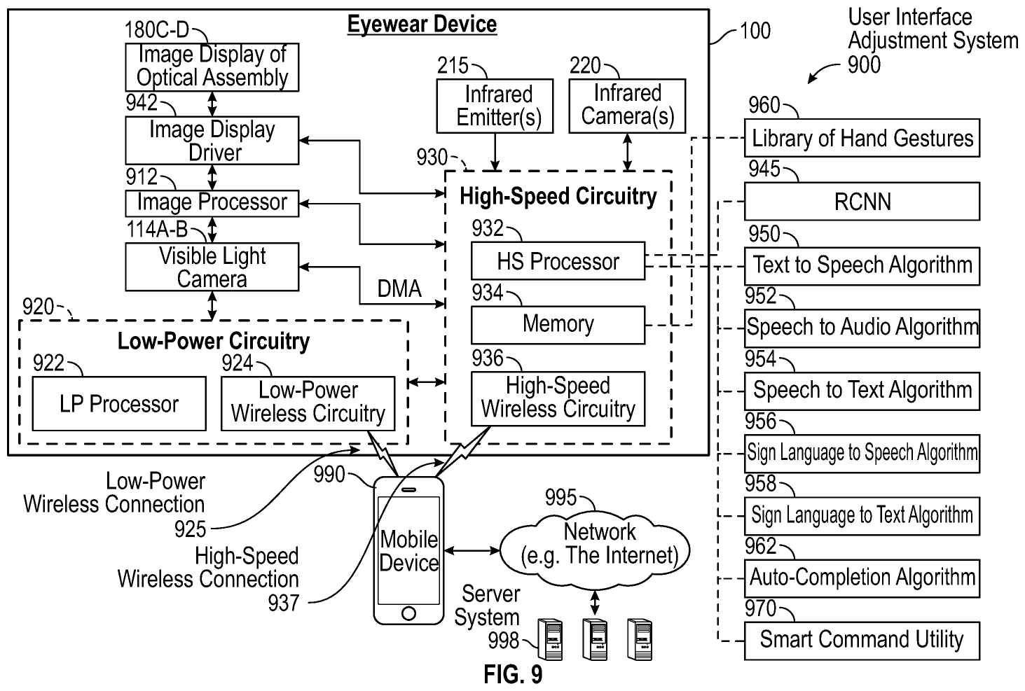

To provide stereoscopic vision, visible light cameras 114A-B may be coupled to an image processor (element 912 of FIG. 9) for digital processing along with a timestamp in which the image of the scene is captured. Image processor 912 includes circuitry to receive signals from the visible light camera 114A-B and process those signals from the visible light cameras 114A-B into a format suitable for storage in the memory (element 934 of FIG. 9). The timestamp can be added by the image processor 912 or other processor, which controls operation of the visible light cameras 114A-B. Visible light cameras 114A-B allow the stereo camera to simulate human binocular vision. Stereo cameras provide the ability to reproduce three-dimensional images (element 715 of FIG. 7) based on two captured images (elements 758A-B of FIG. 7) from the visible light cameras 114A-B, respectively, having the same timestamp. Such three-dimensional images 715 allow for an immersive life-like experience, e.g., for virtual reality or video gaming. For stereoscopic vision, the pair of images 758A-B are generated at a given moment in time—one image for each of the visible light cameras 114A-B. When the pair of generated images 758A-B from the frontward facing angles of coverage 111A-B of the visible light cameras 114A-B are stitched together (e.g., by the image processor 912), depth perception is provided by the optical assembly 180A-B.

In an example, a user interface field of view adjustment system includes the eyewear device 100. The eyewear device 100 includes a frame 105, a temple portion 110B extending from a lateral side 170B of the frame 105, and a see-through image display 180D (FIGS. 2A-B) comprising optical assembly 180B to present a graphical user interface to a user. The eyewear device 100 includes a visible light camera 114A connected to the frame 105 or a temple portion 110A to capture an image of the scene. Eyewear device 100 further includes another visible light camera 114B connected to the frame 105 or another temple portion 110B to capture (e.g., at least substantially simultaneously with the visible light camera 114A) another image of the scene, which partially overlaps the image. Although not shown in FIGS. 1A-B, the user interface field of view adjustment system further includes the processor 932 coupled to the eyewear device 100 and connected to the visible light cameras 114A-B, the memory 934 accessible to the processor 932, and programming in the memory 934, for example in the eyewear device 100 itself or another part of the user interface field of view adjustment system.

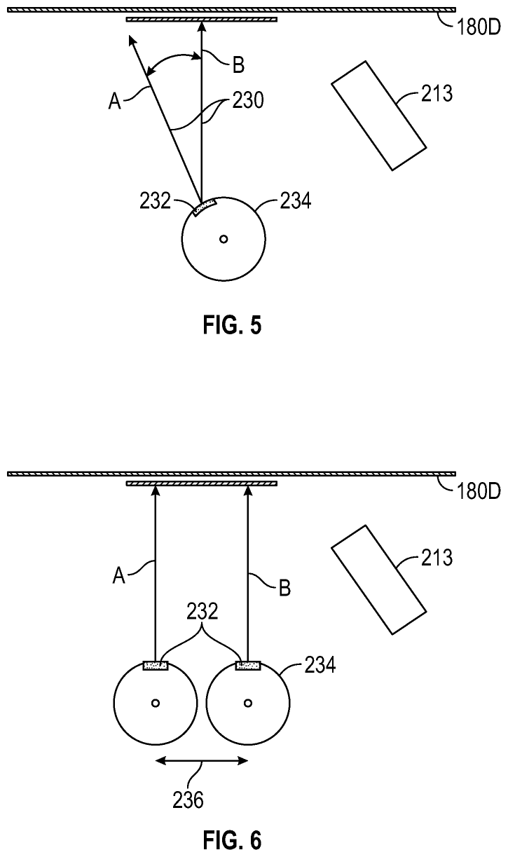

Although not shown in FIG. 1A, the eyewear device 100 also includes a head movement tracker (element 109 of FIG. 1B) or an eye movement tracker (element 213 of FIG. 2B). Eyewear device 100 further includes the see-through image displays 180C-D of optical assembly 180A-B for presenting a sequence of displayed images, and an image display driver (element 942 of FIG. 9) coupled to the see-through image displays 180C-D of optical assembly 180A-B to control the image displays 180C-D of optical assembly 180A-B to present the sequence of displayed images 715, which are described in further detail below. Eyewear device 100 further includes the memory 934 and the processor 932 having access to the image display driver 942 and the memory 934. Eyewear device 100 further includes programming (element 934 of FIG. 9) in the memory. Execution of the programming by the processor 932 configures the eyewear device 100 to perform functions, including functions to present, via the see-through image displays 180C-D, an initial displayed image of the sequence of displayed images, the initial displayed image having an initial field of view corresponding to an initial head direction or an initial eye gaze direction (element 230 of FIG. 5).

Execution of the programming by the processor 932 further configures the eyewear device 100 to detect movement of a user of the eyewear device by: (i) tracking, via the head movement tracker (element 109 of FIG. 1), a head movement of a head of the user, or (ii) tracking, via an eye movement tracker (element 213 of FIG. 2B, FIG. 5), an eye movement of an eye of the user of the eyewear device 100. Execution of the programming by the processor 932 further configures the eyewear device 100 to determine a field of view adjustment to the initial field of view of the initial displayed image based on the detected movement of the user. The field of view adjustment includes a successive field of view corresponding to a successive head direction or a successive eye direction. Execution of the programming by the processor 932 further configures the eyewear device 100 to generate a successive displayed image of the sequence of displayed images based on the field of view adjustment. Execution of the programming by the processor 932 further configures the eyewear device 100 to present, via the see-through image displays 180C-D of the optical assembly 180A-B, the successive displayed images.

FIG. 1B is a top cross-sectional view of the temple of the eyewear device 100 of FIG. 1A depicting the visible light camera 114B, a head movement tracker 109, and a circuit board. Construction and placement of the visible light camera 114A is substantially similar to the visible light camera 114B, except the connections and coupling are on the lateral side 170A. As shown, the eyewear device 100 includes the visible light camera 114B and a circuit board, which may be a flexible printed circuit board (PCB) 140. The hinge 126B connects the temple portion 110B to a temple 125B of the eyewear device 100. In some examples, components of the visible light camera 114B, the flexible PCB 140, or other electrical connectors or contacts may be located on the temple 125B or the hinge 126B.

As shown, eyewear device 100 has a head movement tracker 109, which includes, for example, an inertial measurement unit (IMU). An inertial measurement unit is an electronic device that measures and reports a body's specific force, angular rate, and sometimes the magnetic field surrounding the body, using a combination of accelerometers and gyroscopes, sometimes also magnetometers. The inertial measurement unit works by detecting linear acceleration using one or more accelerometers and rotational rate using one or more gyroscopes. Typical configurations of inertial measurement units contain one accelerometer, gyro, and magnetometer per axis for each of the three axes: horizontal axis for left-right movement (X), vertical axis (Y) for top-bottom movement, and depth or distance axis for up-down movement (Z). The accelerometer detects the gravity vector. The magnetometer defines the rotation in the magnetic field (e.g., facing south, north, etc.) like a compass which generates a heading reference. The three accelerometers to detect acceleration along the horizontal, vertical, and depth axis defined above, which can be defined relative to the ground, the eyewear device 100, or the user wearing the eyewear device 100.

Eyewear device 100 detects movement of the user of the eyewear device 100 by tracking, via the head movement tracker 109, the head movement of the head of the user. The head movement includes a variation of head direction on a horizontal axis, a vertical axis, or a combination thereof from the initial head direction during presentation of the initial displayed image on the image display. In one example, tracking, via the head movement tracker 109, the head movement of the head of the user includes measuring, via the inertial measurement unit 109, the initial head direction on the horizontal axis (e.g., X axis), the vertical axis (e.g., Y axis), or the combination thereof (e.g., transverse or diagonal movement). Tracking, via the head movement tracker 109, the head movement of the head of the user further includes measuring, via the inertial measurement unit 109, a successive head direction on the horizontal axis, the vertical axis, or the combination thereof during presentation of the initial displayed image.

Tracking, via the head movement tracker 109, the head movement of the head of the user further includes determining the variation of head direction based on both the initial head direction and the successive head direction. Detecting movement of the user of the eyewear device 100 further includes in response to tracking, via the head movement tracker 109, the head movement of the head of the user, determining that the variation of head direction exceeds a deviation angle threshold on the horizontal axis, the vertical axis, or the combination thereof. The deviation angle threshold is between about 3° to 10°. As used herein, the term “about” when referring to an angle means±10% from the stated amount.

Variation along the horizontal axis slides three-dimensional objects, such as characters, Bitmojis, application icons, etc. in and out of the field of view by, for example, hiding, unhiding, or otherwise adjusting visibility of the three-dimensional object. Variation along the vertical axis, for example, when the user looks upwards, in one example, displays weather information, time of day, date, calendar appointments, etc. In another example, when the user looks downwards on the vertical axis, the eyewear device 100 may power down.

The temple portion 110B includes temple body 211 and a temple cap, with the temple cap omitted in the cross-section of FIG. 1B. Disposed inside the temple portion 110B are various interconnected circuit boards, such as PCBs or flexible PCBs, that include controller circuits for visible light camera 114B, microphone(s) 130, speaker(s) 132, low-power wireless circuitry (e.g., for wireless short-range network communication via Bluetooth™), high-speed wireless circuitry (e.g., for wireless local area network communication via WiFi).

The visible light camera 114B is coupled to or disposed on the flexible PCB 140 and covered by a visible light camera cover lens, which is aimed through opening(s) formed in the temple portion 110B. In some examples, the frame 105 connected to the temple portion 110B includes the opening(s) for the visible light camera cover lens. The frame 105 includes a front-facing side configured to face outwards away from the eye of the user. The opening for the visible light camera cover lens is formed on and through the front-facing side. In the example, the visible light camera 114B has an outwards facing angle of coverage 111B with a line of sight or perspective of an eye (e.g., right eye) of the user of the eyewear device 100. The visible light camera cover lens can also be adhered to an outwards facing surface of the temple portion 110B in which an opening is formed with an outwards facing angle of coverage, but in a different outwards direction. The coupling can also be indirect via intervening components.

A visible light camera 114A is connected to the see-through image display 180C of optical assembly 180A to generate a background scene of a successive displayed image. Another visible light camera 114B is connected to the see-through image display 180D of optical assembly 180B to generate another background scene of a successive displayed image. The background scenes partially overlap to present a three-dimensional observable area of the successive displayed image.

Flexible PCB 140 is disposed inside the temple portion 110B and is coupled to one or more other components housed in the temple portion 110B. Although shown as being formed on the circuit boards of the temple portion 110B, the visible light camera 114B can be formed on the circuit boards of the temple portion 110A, the temples 125A-B, or frame 105.

FIG. 2A is a rear view of an example hardware configuration of an eyewear device 100, which includes an eye scanner 113 on a frame 105, for use in a system for determining an eye position and gaze direction of a wearer/user of the eyewear device 100. As shown in FIG. 2A, the eyewear device 100 is in a form configured for wearing by a user, which are eyeglasses in the example of FIG. 2A. The eyewear device 100 can take other forms and may incorporate other types of frameworks, for example, a headgear, a headset, or a helmet.

In the eyeglasses example, eyewear device 100 includes the frame 105 which includes the rim 107A connected to the rim 107B via the bridge 106 adapted for a nose of the user. The rims 107A-B include respective apertures 175A-B which hold the respective optical element 180A-B, such as a lens and the see-through displays 180C-D. As used herein, the term lens is meant to cover transparent or translucent pieces of glass or plastic having curved and flat surfaces that cause light to converge/diverge or that cause little or no convergence/divergence.

Although shown as having two optical elements 180A-B, the eyewear device 100 can include other arrangements, such as a single optical element depending on the application or intended user of the eyewear device 100. As further shown, eyewear device 100 includes the temple portion 110A adjacent the lateral side 170A of the frame 105 and the temple portion 110B adjacent the lateral side 170B of the frame 105. The temple portions 110A-B may be integrated into the frame 105 on the respective sides 170A-B (as illustrated) or implemented as separate components attached to the frame 105 on the respective sides 170A-B. Alternatively, the temple portions 110A-B may be integrated into the temples 125A-B or other pieces (not shown) attached to the frame 105.

In the example of FIG. 2A, the eye scanner 113 includes an infrared emitter 115 and an infrared camera 120. Visible light cameras typically include a blue light filter to block infrared light detection, in an example, the infrared camera 120 is a visible light camera, such as a low-resolution video graphic array (VGA) camera (e.g., 640×480 pixels for a total of 0.3 megapixels), with the blue filter removed. The infrared emitter 115 and the infrared camera 120 are co-located on the frame 105, for example, both are shown as connected to the upper portion of the rim 107A. The frame 105 or one or more of the temple portions 110A-B include a circuit board (not shown) that includes the infrared emitter 115 and the infrared camera 120. The infrared emitter 115 and the infrared camera 120 can be connected to the circuit board by soldering, for example.

Other arrangements of the infrared emitter 115 and infrared camera 120 can be implemented, including arrangements in which the infrared emitter 115 and infrared camera 120 are both on the rim 107B, or in different locations on the frame 105, for example, the infrared emitter 115 is on the rim 107A and the infrared camera 120 is on the rim 107B. In another example, the infrared emitter 115 is on the frame 105 and the infrared camera 120 is on one of the temple portions 110A-B, or vice versa. The infrared emitter 115 can be connected essentially anywhere on the frame 105, temple portion 110A, or temple portion 110B to emit a pattern of infrared light. Similarly, the infrared camera 120 can be connected essentially anywhere on the frame 105, temple portion 110A, or temple portion 110B to capture at least one reflection variation in the emitted pattern of infrared light.

The infrared emitter 115 and infrared camera 120 are arranged to face inwards towards an eye of the user with a partial or full field of view of the eye in order to identify the respective eye position and gaze direction. For example, the infrared emitter 115 and infrared camera 120 are positioned directly in front of the eye, in the upper part of the frame 105 or in the temple portions 110A-B at either ends of the frame 105.

FIG. 2B is a rear view of an example hardware configuration of another eyewear device 200. In this example configuration, the eyewear device 200 is depicted as including an eye scanner 213 on a temple 210B. As shown, an infrared emitter 215 and an infrared camera 220 are co-located on the temple 210B. It should be understood that the eye scanner 213 or one or more components of the eye scanner 213 can be located on the temple 210A and other locations of the eyewear device 200, for example, the frame 105. The infrared emitter 215 and infrared camera 220 are like that of FIG. 2A, but the eye scanner 213 can be varied to be sensitive to different light wavelengths as described previously in FIG. 2A.

Similar to FIG. 2A, the eyewear device 200 includes a frame 105 which includes a rim 107A which is connected to a rim 107B via a bridge 106; and the rims 107A-B include respective apertures which hold the respective optical elements 180A-B comprising the see-through display 180C-D.

FIGS. 2C-D are rear views of example hardware configurations of the eyewear device 100, including two different types of see-through image displays 180C-D. In one example, these see-through image displays 180C-D of optical assembly 180A-B include an integrated image display. As shown in FIG. 2C, the optical assemblies 180A-B includes a suitable display matrix 180C-D of any suitable type, such as a liquid crystal display (LCD), an organic light-emitting diode (OLED) display, a waveguide display, or any other such display. The optical assembly 180A-B also includes an optical layer or layers 176, which can include lenses, optical coatings, prisms, mirrors, waveguides, optical strips, and other optical components in any combination. The optical layers 176A-N can include a prism having a suitable size and configuration and including a surface (e.g., first) for receiving light from display matrix and another surface (e.g., second) for emitting light to the eye of the user. The prism of the optical layers 176A-N extends over all or at least a portion of the respective apertures 175A-B formed in the rims 107A-B to permit the user to see the other surface of the prism when the eye of the user is viewing through the corresponding rim 107A-B. The surface of the prism of the optical layers 176A-N receiving light faces upwardly from the frame 105 and the display matrix overlies the prism so that photons and light emitted by the display matrix impinge the surface. The prism is sized and shaped so that the light is refracted within the prism and is directed towards the eye of the user by the other surface of the prism of the optical layers 176A-N. In this regard, the other surface of the prism of the optical layers 176A-N can be convex to direct the light towards the center of the eye. The prism can optionally be sized and shaped to magnify the image projected by the see-through image displays 180C-D, and the light travels through the prism so that the image viewed from the other surface is larger in one or more dimensions than the image emitted from the see-through image displays 180C-D.

In another example, the see-through image displays 180C-D of optical assembly 180A-B include a projection image display as shown in FIG. 2D. The optical assembly 180A-B includes a laser projector 150, which is a three-color laser projector using a scanning mirror or galvanometer. During operation, an optical source such as a laser projector 150 is disposed in or on one of the temples 125A-B of the eyewear device 100. Optical assembly 180A-B includes one or more optical strips 155A-N spaced apart across the width of the lens of the optical assembly 180A-B or across a depth of the lens between the front surface and the rear surface of the lens.

As the photons projected by the laser projector 150 travel across the lens of the optical assembly 180A-B, the photons encounter the optical strips 155A-N. When a particular photon encounters a particular optical strip, the photon is either redirected towards the user's eye, or it passes to the next optical strip. A combination of modulation of laser projector 150, and modulation of optical strips, may control specific photons or beams of light. In an example, a processor controls optical strips 155A-N by initiating mechanical, acoustic, or electromagnetic signals. Although shown as having two optical assemblies 180A-B, the eyewear device 100 can include other arrangements, such as a single or three optical assemblies, or the optical assembly 180A-B may have arranged different arrangement depending on the application or intended user of the eyewear device 100.

As further shown in FIGS. 2C-D, eyewear device 100 includes a temple portion 110A adjacent the lateral side 170A of the frame 105 and a temple portion 110B adjacent the lateral side 170B of the frame 105. The temple portions 110A-B may be integrated into the frame 105 on the respective lateral sides 170A-B (as illustrated) or implemented as separate components attached to the frame 105 on the respective sides 170A-B. Alternatively, the temple portions 110A-B may be integrated into temples 125A-B attached to the frame 105.

In one example, the see-through image displays include the see-through image display 180C and the see-through image display 180D. Eyewear device 100 includes apertures 175A-B, which hold respective optical assemblies 180A-B. The optical assembly 180A includes the see-through image display 180C (e.g., a display matrix of FIG. 2C or optical strips and a projector not shown)). The optical assembly 180B includes the see-through image display 180D (e.g., a display matrix of FIG. 2C (not shown) or optical strips 155A-N and a projector 150)). The successive field of view of the successive displayed image includes an angle of view between about 150 to 30, and more specifically 24°, measured horizontally, vertically, or diagonally. The successive displayed image having the successive field of view represents a combined three-dimensional observable area visible through stitching together of two displayed images presented on the image displays.

As used herein, “an angle of view” describes the angular extent of the field of view associated with the displayed images presented on each of the image displays 180C-D of optical assembly 180A-B. The “angle of coverage” describes the angle range that a lens of visible light cameras 114A-B or infrared camera 220 can image. Typically, the image circle produced by a lens is large enough to cover the film or sensor completely, possibly including some vignetting (i.e., a reduction of an image's brightness or saturation toward the periphery compared to the image center). If the angle of coverage of the lens does not fill the sensor, the image circle will be visible, typically with strong vignetting toward the edge, and the effective angle of view will be limited to the angle of coverage. The “field of view” is intended to describe the field of observable area which the user of the eyewear device 100 can see through his or her eyes via the displayed images presented on the image displays 180C-D of the optical assembly 180A-B. Image display 180C of optical assembly 180A-B can have a field of view with an angle of coverage between 15° to 30°, for example 24°, and have a resolution of 480×480 pixels.

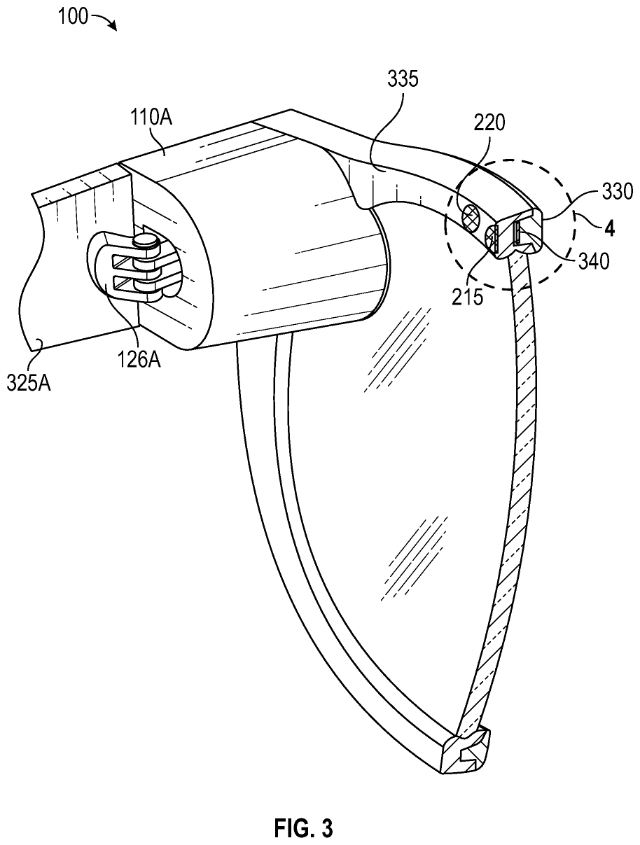

FIG. 3 shows a rear perspective view of the eyewear device of FIG. 2A. The eyewear device 100 includes an infrared emitter 215, infrared camera 220, a frame front 330, a frame back 335, and a circuit board 340. It can be seen in FIG. 3 that the upper portion of the rim of the frame of the eyewear device 100 includes the frame front 330 and the frame back 335. An opening for the infrared emitter 215 is formed on the frame back 335.

As shown in the encircled cross-section 4 in the upper middle portion of the rim of the frame, a circuit board, which is a flexible PCB 340, is sandwiched between the frame front 330 and the frame back 335. Also shown in further detail is the attachment of the temple portion 110A to the temple 325A via the hinge 126A. In some examples, components of the eye movement tracker 213, including the infrared emitter 215, the flexible PCB 340, or other electrical connectors or contacts may be located on the temple 325A or the hinge 126A.

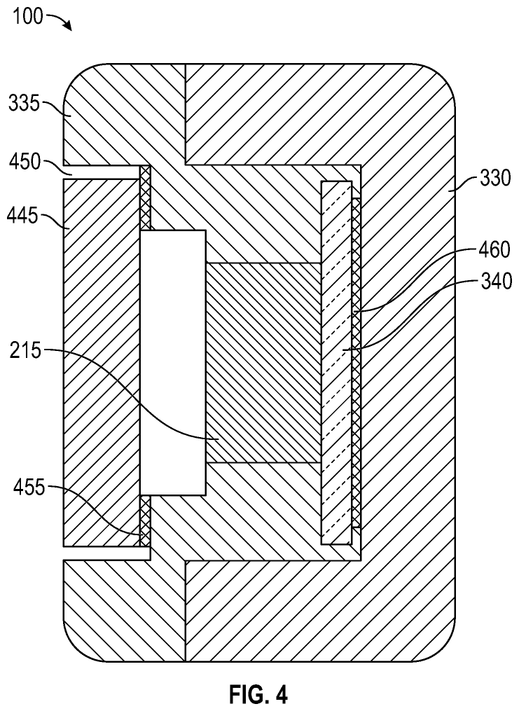

FIG. 4 is a cross-sectional view through the infrared emitter 215 and the frame corresponding to the encircled cross-section 4 of the eyewear device of FIG. 3. Multiple layers of the eyewear device 100 are illustrated in the cross-section of FIG. 4, as shown the frame includes the frame front 330 and the frame back 335. The flexible PCB 340 is disposed on the frame front 330 and connected to the frame back 335. The infrared emitter 215 is disposed on the flexible PCB 340 and covered by an infrared emitter cover lens 445. For example, the infrared emitter 215 is reflowed to the back of the flexible PCB 340. Reflowing attaches the infrared emitter 215 to contact pad(s) formed on the back of the flexible PCB 340 by subjecting the flexible PCB 340 to controlled heat which melts a solder paste to connect the two components. In one example, reflowing is used to surface mount the infrared emitter 215 on the flexible PCB 340 and electrically connect the two components. However, it should be understood that through-holes can be used to connect leads from the infrared emitter 215 to the flexible PCB 340 via interconnects, for example.

The frame back 335 includes an infrared emitter opening 450 for the infrared emitter cover lens 445. The infrared emitter opening 450 is formed on a rear-facing side of the frame back 335 that is configured to face inwards towards the eye of the user. In the example, the flexible PCB 340 can be connected to the frame front 330 via the flexible PCB adhesive 460. The infrared emitter cover lens 445 can be connected to the frame back 335 via infrared emitter cover lens adhesive 455. The coupling can also be indirect via intervening components.

In an example, the processor 932 utilizes eye tracker 213 to determine an eye gaze direction 230 of a wearer's eye 234 as shown in FIG. 5, and an eye position 236 of the wearer's eye 234 within an eyebox as shown in FIG. 6. The eye tracker 213 is a scanner which uses infrared light illumination (e.g., near-infrared, short-wavelength infrared, mid-wavelength infrared, long-wavelength infrared, or far infrared) to captured image of reflection variations of infrared light from the eye 234 to determine the gaze direction 230 of a pupil 232 of the eye 234, and also the eye position 236 with respect to the see-through display 180D.

FIG. 7 depicts an example of capturing visible light with cameras. Visible light is captured by the visible light camera 114A with a visible light camera field of view 111A as a raw image 758A. Visible light is captured by the visible light camera 114B with a visible light camera field of view 111B (having an overlap 713 with the field of view 111A) as a raw image 758B. Based on processing of the raw image 758A and the raw image 758B, a three-dimensional depth map 715 of a three-dimensional scene, referred to hereafter as an image, is generated by processor 932.

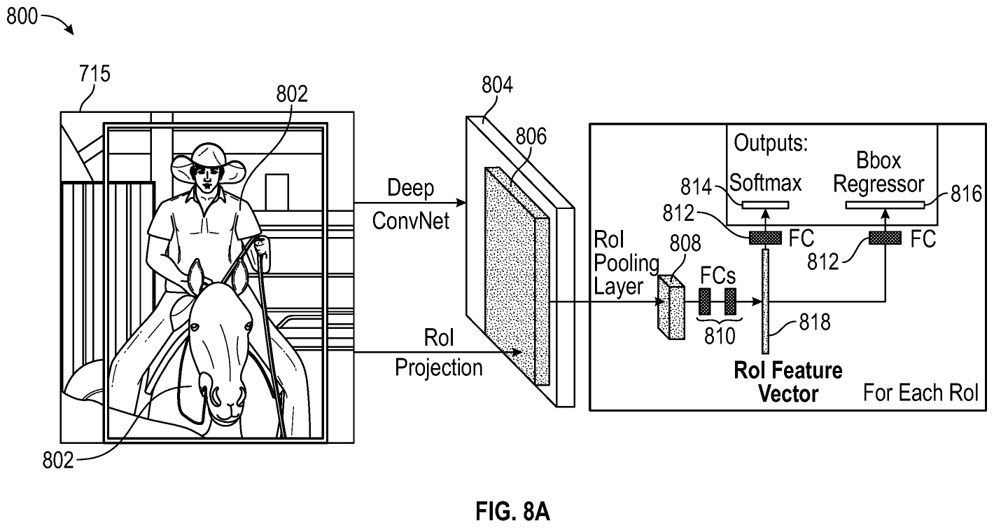

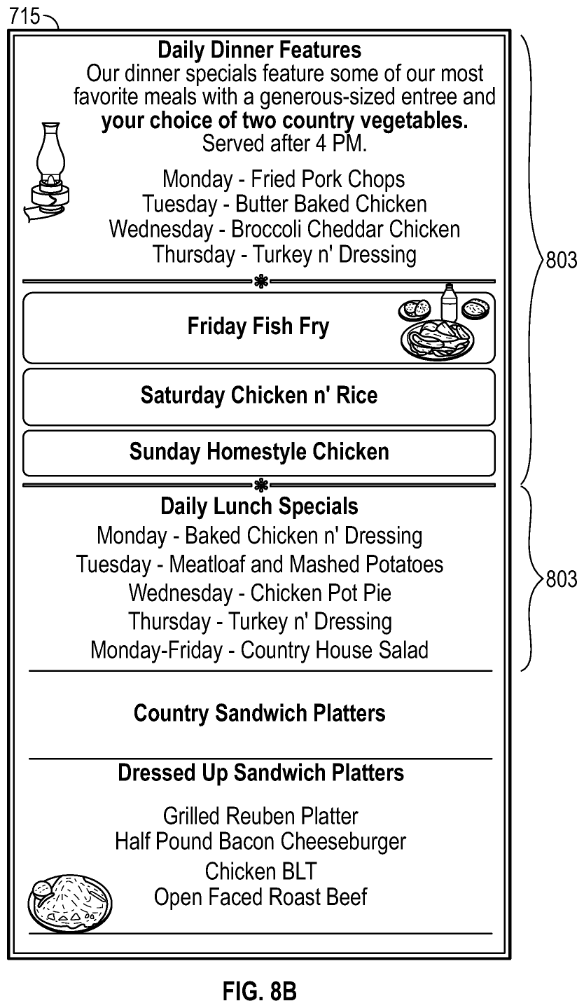

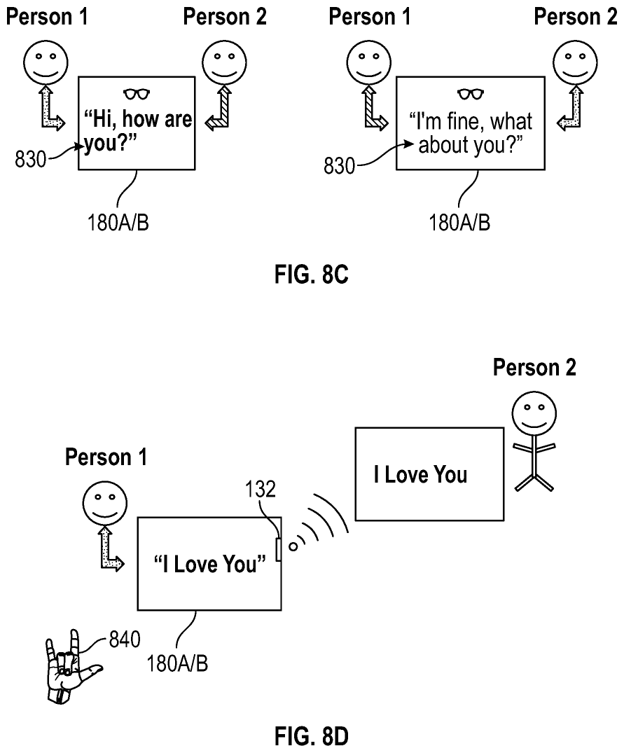

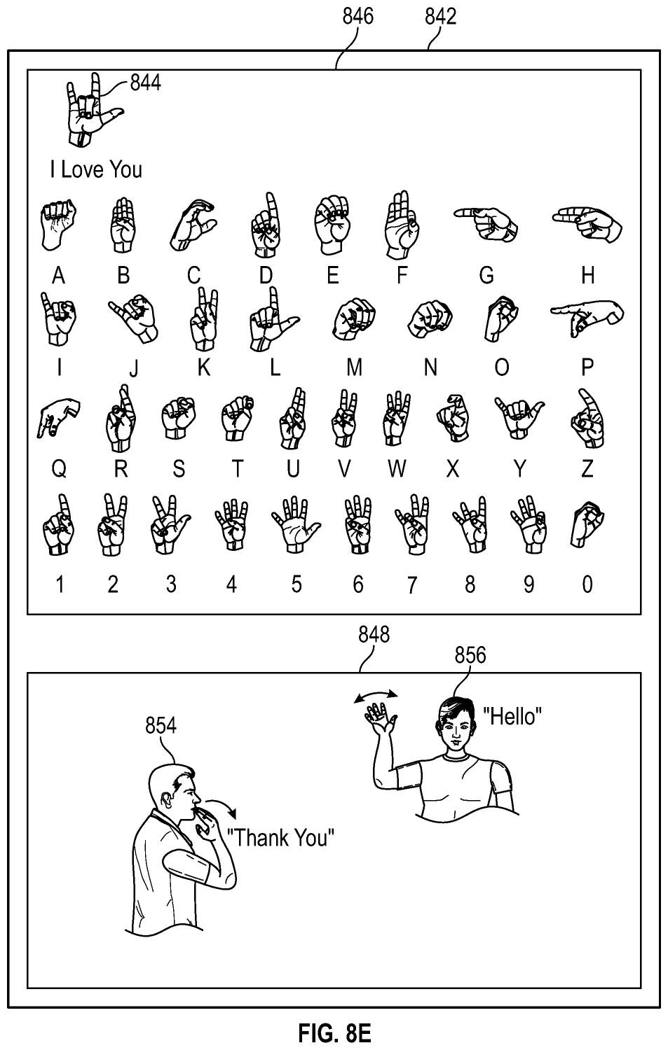

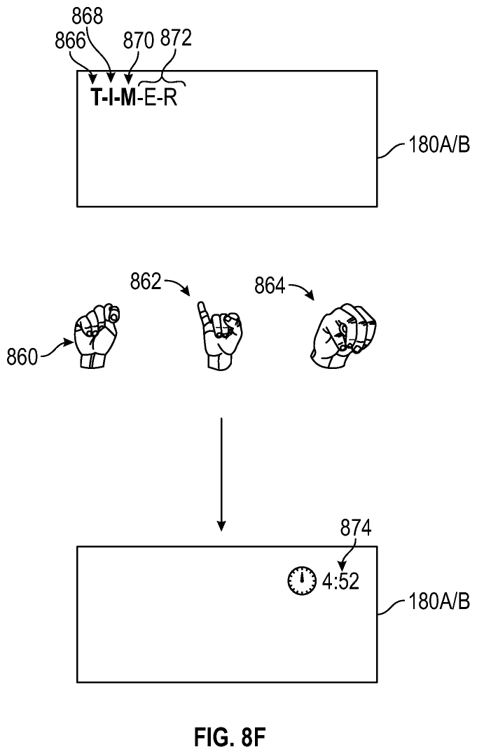

FIG. 8A illustrates an example of a camera-based system 800 processing an image 715 to improve the user experience of users of eyewear 100/200 having partial or total blindness (FIG. 8A, FIG. 8B and FIG. 8C), and for those that are hearing-impaired or deaf (FIG. 8D).

To compensate for partial or total blindness, the camera-based compensation 800 determines objects 802 in image 715, converts determined objects 802 to text, and then converts the text to audio that is indicative of the objects 802 in the image.

FIG. 8B is an image used to illustrate an example of a camera-based compensation system 800 responding to speech of a user, such as instructions, to improve the user experience of users of eyewear 100/200 having partial or total blindness. To compensate for partial or total blindness, the camera-based compensation 800 processes speech, such as instructions, received from a user/wearer of eyewear 100 to determine objects 802 in image 715, such as a restaurant menu, and converts determined objects 802 to audio that is indicative of the objects 802 in the image responsive to the speech command.

A convolutional neural network (CNN) is a special type of feed-forward artificial neural network that is generally used for image detection tasks. In an example, the camera-based compensation system 800 uses a region-based convolutional neural network (RCNN) 945. The RCNN 945 is configured to generate a convolutional feature map 804 that is indicative of objects 802 (FIG. 8A) and 803 (FIG. 8B) in the image 715 produced by the cameras 114A-B. In one example, relevant text of the convolutional feature map 804 is processed by a processor 932 using a text to speech algorithm 950. In another example, images of the convolutional feature map 804 are processed by processor 932 using a speech to audio algorithm 952 to produce audio that is indicative of objects in the image based on the speech instructions. The processor 932 includes a natural language processor configured to generate audio indicative of the objects 802 and 803 in the image 715.

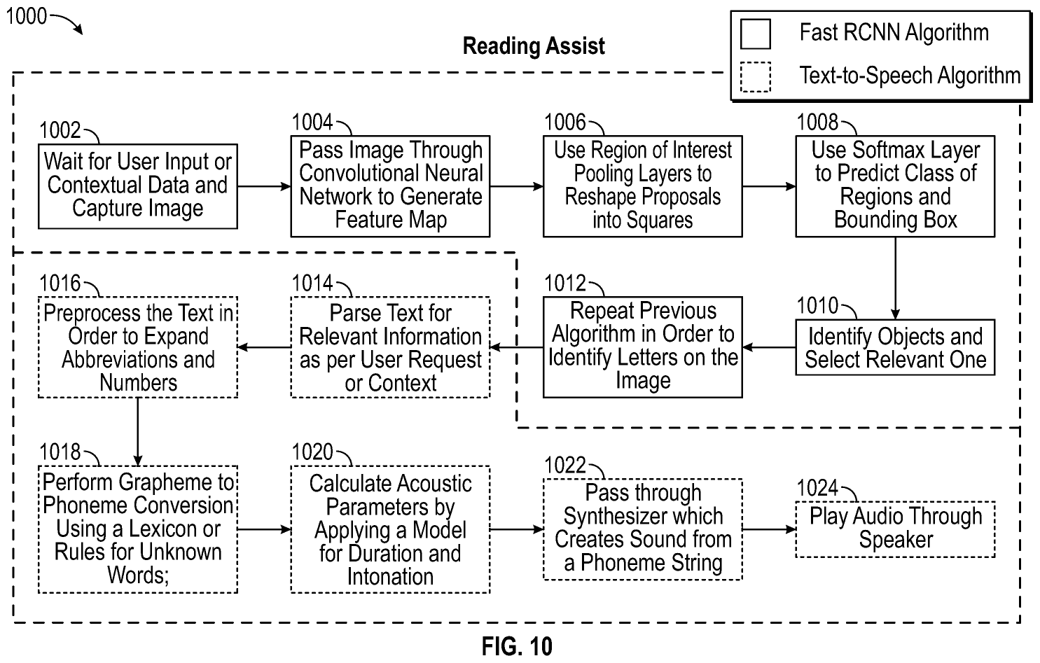

In an example, and as will be discussed in further detail with respect to FIG. 10 below, image 715 generated from the cameras 114A-B, respectively, is shown to include objects 802, seen in this example as a cowboy on a horse in FIG. 8A. The image 715 is input to the RCNN 945 which generates the convolutional feature map 804 based on the image 715. An example RCNN is available from Analytics Vidhya of Gurugram, Haryana, India. From the convolutional feature map 804 the processor 932 identifies a region of proposals in the convolutional feature map 804 and transforms them into squares 806. The squares 806 represent a subset of the image 715 that is less than the whole image 715, where the square 806 shown in this example includes the cowboy on the horse. The region of proposal may be, for example, recognized objects (e.g., a human/cowboy, a horse, etc.) that are moving.

In another example, with reference to FIG. 8B, a user provides speech that is input to eyewear 100/200 using microphone 130 (FIG. 1B) to request certain objects 803 in image 715 to be read aloud via speaker 132. In an example, the user may provide speech to request a portion of a restaurant menu to be read aloud, such as daily dinner features, and daily specials. The RCNN 945 determines portions of the image 715, such as a menu, to identify objects 803 that correspond to the speech request. The processor 932 includes a natural language processor configured to generate audio indicative of the determine objects 803 in the image 715. The processor may additionally track head/eye movement to identify features such as a menu held in the hand of a wearer or a subset/portion of the menu (e.g., the right or left side).

The processor 932 uses a region of interest (ROI) pooling layer 808 to reshape the squares 806 into a uniform size so that they can be input into a fully connected layer 810. A softmax layer 814 is used to predict the class of the proposed ROI based on a fully connected layer 812 and also offset values for a bounding box (bbox) regressor 816 from a ROI feature vector 818.

The relevant text of the convolutional feature map 804 is processed through the text to speech algorithm 950 using the natural language processor 932 and a digital signal processor is used to generate audio that is indicative of the text in the convolutional feature map 804. Relevant text may be text identifying moving objects (e.g., the cowboy and the horse; FIG. 8A) or text of a menu matching a user's request (e.g., list of daily specials; FIG. 8B). An example text to speech algorithm 950 is available from DFKI Berlin of Berlin, Germany. Audio can be interpreted using a convolutional neural network, or it may be offloaded to another device or system. The audio is generated using the speaker 132 such that it is audible to the user (FIG. 2A).

In another example, with reference to FIG. 8C, the eyewear 100/200 provides speaker segmentation, referred to as diarization. Diarization is a software technique that segments spoken language into different speakers and remembers that speaker over the course of a session. The RCNN 945 performs the diarization and identifies different speakers that are speaking in proximity to the eyewear 100/200 and indicates who they are by rendering output text differently on the eyewear display 180A and 180B. In an example, the processor 932 uses a speech to text algorithm 954 to process the text generated by the RCNN 945 and display the text on displays 180A and 180B. The microphone 130 shown in FIG. 2A captures the speech of one or more human speakers in proximity to the eyewear 100/200. In the context of eyewear 100/200 and speech recognition, information 830 displayed on one or both displays 180A and 180B indicates the text transcribed from the speech and includes the information relative to the person speaking such that the eyewear user can distinguish the transcribed text of multiple speakers. The text 830 of each user has a different attribute such that the eyewear user can distinguish the text 830 of different speakers. FIG. 8C shows an example diarization in the captioning user experience (UX), where the attribute is a color randomly assigned to the displayed text whenever a new speaker is detected. For instance, the displayed text associated with person 1 is displayed in blue, and the displayed text associated with person 2 is displayed in green. In other examples, the attribute is a font type or font size of the displayed text 830 associated with each person. The location the text 830 displayed on the displays 180A and 180B is chosen such that vision of the eyewear user through the display 180A and 180B is not substantially obstructed.

In another example, with reference to FIG. 8D and FIG. 8E, the eyewear 100/200 provides translation of sign language of a user to speech for a hearing-impaired/deaf user. The cameras 114A and 114B image hand gestures 840 representing sign language presented by the user, and the RCNN 945 translates the hand gestures 840 to enable the user of eyewear 100/200 to produce speech that can be heard and understood by another person and have a conversation. FIG. 8E illustrates a set 842 of hand gestures 840, such as those of the American Sign Language (ASL), stored in a library of hand gestures 960 that is stored in memory 934 (FIG. 9). The user can generate sign language that is static or moving. The camera-based compensation system 800 detects and processes the user's hand gestures 840 presenting the sign language and generates speech using speaker 132 (FIG. 1B) that is a translation of the presented sign language to improve the user experience of users of eyewear 100/200. The translation can be of a static hand gesture, of a series of static hand gestures representing the word L-O-V-E, or of a moving hand gesture. The camera-based compensation 800 uses cameras 114A and 114B to capture respective camera images in their FOV, including hand gestures 840, and generates images 715 (FIG. 7) including the sign language. The camera-based system 800 then forwards the images 715 to an image processor 912 and processor 932 (FIG. 9) for processing. The processor 932 utilizes a sign language to speech algorithm 956 to translate the sign language to speech.

The RCNN 945 is configured to generate a convolutional feature map 804 that is indicative of the detected hand gestures 840 including sign language forming objects 802. In one example, the hand gestures 840 of sign language forming objects 802 of the convolutional feature map 804 are processed by a processor 932 using the sign language to speech algorithm 956 to produce speech that is a translation of the sign language in the image 715. The processor 932 includes the natural language processor configured to compare the detected sign language of hand gestures 840 to the set of hand gestures 842 stored in the library of hand gestures 960 stored in memory 934 for a match. When a detected sign language is determined by the processor 932 to match one of the hand gestures in the library of hand gestures 960, the processor 932 generates speech audio using speaker 132 that is a translation of the sign language.

In an example, referring to FIG. 8E, there is illustrated the set of hand gestures 842 including a set of static hand gestures 846, and a set of moving hand gestures 848. As shown, examples of static hand gestures 846 can include the English alphabet, English numbers, and complex hand signals such as those to indicate “I love you” as shown at 844. Examples of moving hand gestures include “thank you” as shown at 854, which is the motion of a hand extending away from a user's mouth, and as shown at 856 which is the motion of a hand extending away from a user's forehead.

In an example, referring to FIG. 8F, the eyewear 100/200 provides translation of sign language presented by a user to a smart command that is a predefined function. The RCNN 945 translates hand gestures 860, 862, and 864 captured by cameras 114A and 114B, which represent sign language presented by the user to enable the user of eyewear 100/200 to initiate smart commands (using sign language) that enable various functions of the eyewear 100/200. The processor 932 executes a sign language to text algorithm 958 to translate the sign language to text to be used by a smart command utility 970.

In the example of FIG. 8F, the camera-based compensation system 800 detects and processes the user's hand gestures 860, 862, and 864, presenting the sign language, and generates text, 866, 868, and 870 on the display 180A/B using the sign language to text algorithm 958. In an example, the user signs the word “Timer” in American Sign Language to initiate a smart command of a timer. The static gesture 860 is ASL for “T” (866), the static gesture 862 is ASL for “I” (868), and the static gesture 864 is ASL for “M” (870). As the user spells the command, the processor 932 auto-completes the spelling by predicting the command of a user using an auto-completion algorithm 962. The suggested auto complete letter, word, or phrase 872 is displayed to the user on display 180A/B to be confirmed by the user before initiating the command. In another example, the auto-completion of the command doesn't require a confirmation and runs the command once it is predicted. In the example of the timer, once the smart command is initiated, a prompt is displayed to the user asking the allotted time of the timer and the user sets the time with a hand gesture, such as the ASL gesture for “5”. A timer 874 is started by the eyewear 100/200 and displayed on the display 180A/B.

The gesture based smart commands include a variety of functionalities that provide for a convenient interface for the user. In another example, a user can fingerspell ‘R’-‘E’-‘C’-‘I’-‘P’-‘E’. Next, the eyewear 100/200 prompts the user to spell out the recipe. When the user fingerspells or gestures the recipe's name, the eyewear 100/200 will play a corresponding recipe video on the display 180A/B. For example, the user finger spells ‘C’-‘A’-‘K’-‘E’ and a video of a recipe for cake is displayed on the display 180A/B. Alternatively, a list of multiple cake recipes is displayed to the user wherein the user is prompted again to select the desired video or recipe. Other smart commands may include, but are not limited to, capturing an image, recording a video, initiating a video call, setting an alarm, conducting an internet search, using a calculator, getting directions, sending a message or replying to a message (e.g., a text message or messaging application), asking for the time, or additional functionalities with a third-party application.

The algorithms 950, 952, 954, 956, 958, and 962 are a set of algorithms individually selectable by a user of the eyewear 100/200, and executable by the processor 932. The algorithms can be executed one a time, or simultaneously.

FIG. 9 depicts a high-level functional block diagram including example electronic components disposed in eyewear 100/200. The illustrated electronic components include the processor 932, which executes the RCNN 945, the text to speech algorithm 950, the speech to audio algorithm 952, the speech to text algorithm 954, the sign language to speech algorithm 956, the sign language to text algorithm 958, the smart command utility 970, and the auto-completion algorithm 962.

Memory 934 includes instructions including computer readable code for execution by processor 932 to implement functionality of eyewear 100/200, including instructions (code) for processor 932 to perform RCNN 945, the text to speech algorithm 950, the speech to audio algorithm 952, the speech to text algorithm 954, the sign language to speech algorithm 956, the sign language to text algorithm 958, the smart command utility 970, and the auto-completion algorithm 962. Processor 932 receives power from battery (not shown) and executes the instructions stored in memory 934, or integrated with the processor 932 on-chip, to perform functionality of eyewear 100/200, and communicating with external devices via wireless connections.

A user interface adjustment system 900 includes a wearable device, which is the eyewear device 100 with an eye movement tracker 213 (e.g., shown as infrared emitter 215 and infrared camera 220 in FIG. 2B). User interface adjustments system 900 also includes a mobile device 990 and a server system 998 connected via various networks. Mobile device 990 may be a smartphone, tablet, laptop computer, access point, or any other such device capable of connecting with eyewear device 100 using both a low-power wireless connection 925 and a high-speed wireless connection 937. Mobile device 990 is connected to server system 998 and network 995. The network 995 may include any combination of wired and wireless connections.

Eyewear device 100 includes at least two visible light cameras 114A-B (e.g., one associated with each lateral side 170A-B). Eyewear device 100 further includes see-through image displays 180C-D of the optical assembly 180A-B (e.g., one associated with each lateral side 170A-B). The image displays 180C-D are optional in this disclosure. Eyewear device 100 also includes image display driver 942, image processor 912, low-power circuitry 920, and high-speed circuitry 930. The components shown in FIG. 9 for the eyewear device 100 are located on one or more circuit boards, for example a PCB or flexible PCB, in the temples. Alternatively, or additionally, the depicted components can be located in the temples, frames, hinges, or bridge of the eyewear device 100. The visible light cameras 114A-B can include digital camera elements such as a complementary metal-oxide-semiconductor (CMOS) image sensor, charge coupled device, a lens, or any other respective visible or light capturing elements that may be used to capture data, including images of scenes with unknown objects.

Eye movement tracking programming 945 implements the user interface field of view adjustment instructions, including, to cause the eyewear device 100 to track, via the eye movement tracker 213, the eye movement of the eye of the user of the eyewear device 100. Other implemented instructions (functions) cause the eyewear device 100 to determine, a field of view adjustment to the initial field of view of an initial displayed image based on the detected eye movement of the user corresponding to a successive eye direction. Further implemented instructions generate a successive displayed image of the sequence of displayed images based on the field of view adjustment. The successive displayed image is produced as visible output to the user via the user interface. This visible output appears on the see-through image displays 180C-D of optical assembly 180A-B, which is driven by image display driver 942 to present the sequence of displayed images, including the initial displayed image with the initial field of view and the successive displayed image with the successive field of view.

As shown in FIG. 9, high-speed circuitry 930 includes high-speed processor 932, memory 934, and high-speed wireless circuitry 936. In the example, the image display driver 942 is coupled to the high-speed circuitry 930 and operated by the high-speed processor 932 in order to drive the image displays 180C-D of the optical assembly 180A-B. High-speed processor 932 may be any processor capable of managing high-speed communications and operation of any general computing system needed for eyewear device 100. High-speed processor 932 includes processing resources needed for managing high-speed data transfers on high-speed wireless connection 937 to a wireless local area network (WLAN) using high-speed wireless circuitry 936. In certain examples, the high-speed processor 932 executes an operating system such as a LINUX operating system or other such operating system of the eyewear device 100 and the operating system is stored in memory 934 for execution. In addition to any other responsibilities, the high-speed processor 932 executing a software architecture for the eyewear device 100 is used to manage data transfers with high-speed wireless circuitry 936. In certain examples, high-speed wireless circuitry 936 is configured to implement Institute of Electrical and Electronic Engineers (IEEE) 802.11 communication standards, also referred to herein as WiFi. In other examples, other high-speed communications standards may be implemented by high-speed wireless circuitry 936.

Low-power wireless circuitry 924 and the high-speed wireless circuitry 936 of the eyewear device 100 can include short range transceivers (Bluetooth™) and wireless wide, local, or wide area network transceivers (e.g., cellular or WiFi). Mobile device 990, including the transceivers communicating via the low-power wireless connection 925 and high-speed wireless connection 937, may be implemented using details of the architecture of the eyewear device 100, as can other elements of network 995.

Memory 934 includes any storage device capable of storing various data and applications, including, among other things, color maps, camera data generated by the visible light cameras 114A-B and the image processor 912, as well as images generated for display by the image display driver 942 on the see-through image displays 180C-D of the optical assembly 180A-B. While memory 934 is shown as integrated with high-speed circuitry 930, in other examples, memory 934 may be an independent standalone element of the eyewear device 100. In certain such examples, electrical routing lines may provide a connection through a chip that includes the high-speed processor 932 from the image processor 912 or low-power processor 922 to the memory 934. In other examples, the high-speed processor 932 may manage addressing of memory 934 such that the low-power processor 922 will boot the high-speed processor 932 any time that a read or write operation involving memory 934 is needed.

Server system 998 may be one or more computing devices as part of a service or network computing system, for example, that include a processor, a memory, and network communication interface to communicate over the network 995 with the eyewear device 100 via high-speed wireless circuitry 936, either directly, or via the mobile device 990. Eyewear device 100 is connected with a host computer. In one example, the eyewear device 100 wirelessly communicates with the network 995 directly, without using the mobile device 990, such as using a cellular network or WiFi. In another example, the eyewear device 100 is paired with the mobile device 990 via the high-speed wireless connection 937 and connected to the server system 998 via the network 995.

Output components of the eyewear device 100 include visual components, such as the image displays 180C-D of optical assembly 180A-B as described in FIGS. 2C-D (e.g., a display such as a liquid crystal display (LCD), a plasma display panel (PDP), a light emitting diode (LED) display, a projector, or a waveguide). The image displays 180C-D of the optical assembly 180A-B are driven by the image display driver 942. The output components of the eyewear device 100 further include acoustic components (e.g., speakers), haptic components (e.g., a vibratory motor), other signal generators, and so forth. The input components of the eyewear device 100, the mobile device 990, and server system 998, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

Eyewear device 100 may optionally include additional peripheral device elements. Such peripheral device elements may include biometric sensors, additional sensors, or display elements integrated with eyewear device 100. For example, peripheral device elements may include any I/O components including output components, motion components, position components, or any other such elements described herein.

For example, the biometric components of the user interface field of view adjustment 900 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), WiFi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over wireless connections 925 and 937 from the mobile device 990 via the low-power wireless circuitry 924 or high-speed wireless circuitry 936.

According to some examples, an “application” or “applications” are program(s) that execute functions defined in the programs. Various programming languages can be employed to generate one or more of the applications, structured in a variety of manners, such as object-oriented programming languages (e.g., Objective-C, Java, or C++) or procedural programming languages (e.g., C or assembly language). In a specific example, a third-party application (e.g., an application developed using the ANDROID™ or IOS™ software development kit (SDK) by an entity other than the vendor of the particular platform) may be mobile software running on a mobile operating system such as IOS™, ANDROID™ WINDOWS® Phone, or another mobile operating systems. In this example, the third-party application can invoke API calls provided by the operating system to facilitate functionality described herein.

FIG. 10 is a flowchart 1000 illustrating the operation of the eyewear device 100/200 and other components of the eyewear performed by the high-speed processor 932 executing instructions stored in memory 934. Although shown as occurring serially, the blocks of FIG. 10 may be reordered or parallelized depending on the implementation.

Blocks 1002-1010 may be performed using the RCNN 945.

At block 1002, the processor 932 waits for user input or contextual data and image capture. In an example, the input is the image 715 generated from the cameras 114A-B, respectively, and shown to include objects 802 shown in FIG. 8A as a cowboy on a horse in this example. In another example, the input also includes speech from a user/wearer via microphone 130, such as verbal instructions to read an object 803 in an image 715 placed in front of the eyewear 100, shown in FIG. 8B. This can include speech to read a restaurant menu or portion thereof, such as the daily features.

At block 1004, the processor 932 passes image 715 through the RCNN 945 to generate the convolutional feature map 804. The processor 932 uses a convolutional layer using a filter matrix over an array of image pixels in image 715 and performs a convolutional operation to obtain the convolution feature map 804.

At block 1006, the processor 932 uses the ROI pooling layers 808 to reshape a region of proposals of the convolutional feature map 804 into squares 806. The processor is programmable to determine the shape and size of the squares 806 to determine how many objects are processed and to avoid information overload. ROI pooling layer 808 is an operation used in object detection tasks using convolutional neural networks. For example, to detect the cowboy 802 on the horse in a single image 715 shown in FIG. 8A in an example, and to detect menu information 803 shown in FIG. 8B in another example. The ROI pooling layer 808 purpose is to perform max pooling on inputs of nonuniform sizes to obtain fixed-size feature maps (e.g., 7×7 units).

At block 1008, the processor 932 processes the fully connected layers 810, where the softmax layer 814 uses fully connected layer 812 to predict the class of the proposed regions and the bounding box regressor 816. A softmax layer is typically the final output layer in a neural network that performs multi-class classification (for example: object recognition).

At block 1010, the processor 932 identifies objects 802 and 803 in the image 715 and selects relevant features such as objects 802 and 803. The processor 932 is programmable to identify and select different classes of objects 802 and 803 in the squares 806, for example, traffic lights of a roadway and the color of the traffic lights. In another example, the processor 932 is programmed to identify and select moving objects in square 806 such as vehicles, trains, and airplanes. In another example the processor is programmed to identify and select signs, such as pedestrian crossings, warning signs and informational signs. In the example shown in FIG. 8A, the processor 932 identifies the relevant objects 802 as the cowboy and the horse. In the example shown in FIG. 8B, the processor identifies the relevant objects 803 (e.g., based on user instructions) such as the menu portions, e.g., daily dinner specials and daily lunch specials.

At block 1012, blocks 1002-1010 are repeated in order to identify letters and text in the image 715. Processor 932 identifies the relevant letters and text. The relevant letters and text may be determined to be relevant, in one example, if they occupy a minimum portion of the image 715, such as 1/1000 of the image or greater. This limits the processing of smaller letters and text that are not of interest. The relevant objects, letters and text are referred to as features, and are all submitted to the text to speech algorithm 950.

Blocks 1014-1024 are performed by the text to speech algorithm 950 and speech to audio algorithm 952. Text to speech algorithm 950 and speech to audio algorithm 952 process the relevant objects 802 and 803, letters and texts received from the RCNN 945.

At block 1014, the processor 932 parses text of the image 715 for relevant information as per user request or context. The text is generated by the convolutional feature map 804.

At block 1016, the processor 932 preprocesses the text in order to expand abbreviations and numbers. This can include translating the abbreviations into text words, and numerals into text words.

At block 1018, the processor 932 performs grapheme to phoneme conversion using a lexicon or rules for unknown words. A grapheme is the smallest unit of a writing system of any given language. A phoneme is a speech sound in a given language.

At block 1020, the processor 932 calculates acoustic parameters by applying a model for duration and intonation. Duration is the amount of elapsed time between two events. Intonation is variation in spoken pitch when used, not for distinguishing words as sememes (a concept known as tone), but, rather, for a range of other functions such as indicating the attitudes and emotions of the speaker.

At block 1022, the processor 932 passes the acoustic parameters through a synthesizer to produce sounds from a phoneme string. The synthesizer is a software function executed by the processor 932.

At block 1024, the processor 932 plays audio through speaker 132 that is indicative of features including objects 802 and 803 in image 715, as well as letters and text. The audio can be one or more words having suitable duration and intonation. Audio sounds for words are prerecorded, stored in memory 934 and synthesized, such that any word can be played based on the distinct breakdown of the word. Intonation and duration can be stored in memory 934 as well for specific words in the case of synthesis.

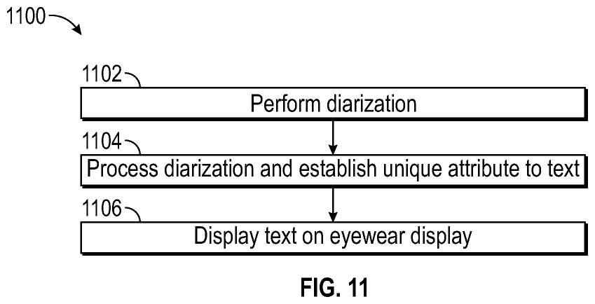

FIG. 11 is a flowchart 1100 illustrating the speech to text algorithm 954 executed by processor 932 to perform diarization of speech generated by multiple speakers, and display text associated with each speaker on the eyewear display 180A and 180B. Although shown as occurring serially, the blocks of FIG. 11 may be reordered or parallelized depending on the implementation.

At block 1102, the processor 932 uses RCNN 945 to perform diarization on spoken language of a plurality of speakers to obtain diarization information. The RCNN 945 performs diarization by segmenting the spoken language into different speakers (e.g., based on speech characteristics) and remembering the respective speaker over the course of a session. The RCNN 945 converts each segment of the spoken language to respective text 830 such that one portion of text 830 represents the speech of a speaker, and another portion of text 830 represents the speech of another speaker, as shown in FIG. 8C. Other techniques for performing diarization include using diarization features available from a third-party provider such as Google, Inc. located in Mountain View, California. The diarization provides text associated with each speaker.

At block 1104, the processor 932 processes the diarization information received from the RCNN 945 and establishes a unique attribute to apply to the text 830 for each speaker. The attribute can take many forms, such as the text color, size, font. The attribute can also include enhanced UX such as user avatars/Bitmojis to go with the text 830. For example, a characteristically male voice will receive a blue color text attribute, a characteristically female voice will receive a pink color text attribute, and a characteristically angry voice (e.g., based on pitch and intonation) will receive a red color text attribute. Additionally, font size of the text 830 may be adjusted by increasing the font attribute based on a decibel level of the speech above a threshold and decreasing the font attribute based on a decibel level of the speech below a another threshold.

At block 1106, the processor 932 displays the text 830 on one or both displays 180A and 180B, as shown in FIG. 8C. The text 830 can be displayed in different locations on the display 180A and 180B and is displayed across the bottom portion of the display as shown in FIG. 8C. The location is chosen such that vision of the user through the display 180A and 180B is not substantially obstructed.

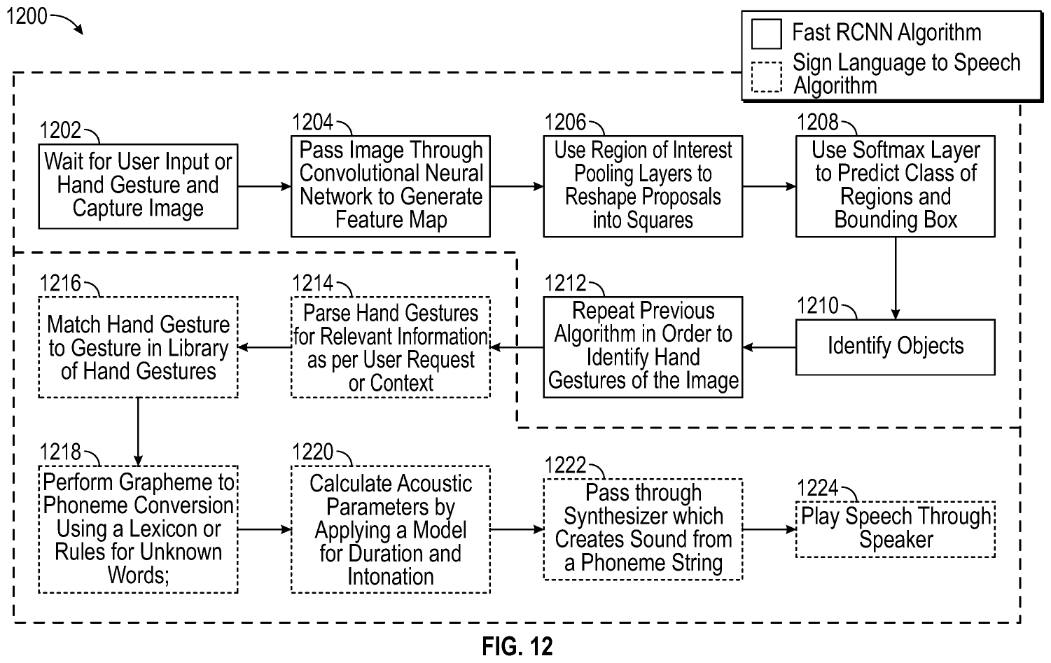

FIG. 12 is a flowchart 1200 illustrating the operation of the eyewear device 100/200 and other components of the eyewear produced by the high-speed processor 932 executing instructions stored in memory 934. FIG. 12 illustrates the sign language to speech algorithm 956 executed by processor 932 to perform translation of sign language to speech, as shown in FIG. 8D. Although shown as occurring serially, the blocks of FIG. 12 may be reordered or parallelized depending on the implementation. Although shown as occurring serially, the blocks of FIG. 12 may be reordered or parallelized depending on the implementation.

Blocks 1202-1210 may be performed using the RCNN 945.

At block 1202, the processor 932 waits for user input including hand gestures, such as sign language, captured in the image 715. In an example, the input is the image 715 generated from the cameras 114A-B, respectively, and shown to include objects 802 shown in FIG. 8D as a hand gestures 840 in this example.

At block 1204, the processor 932 passes image 715 through the RCNN 945 to generate the convolutional feature map 804. The processor 932 uses a convolutional layer using a filter matrix over an array of image pixels in image 715 and performs a convolutional operation to obtain the convolution feature map 804.

At block 1206, the processor 932 uses the ROI pooling layers 808 to reshape a region of proposals of the convolutional feature map 804 into squares 806. The processor 932 is programmable to determine the shape and size of the squares 806 to determine how many objects are processed and to avoid information overload. ROI pooling layer 808 is an operation used in object detection tasks using convolutional neural networks. For example, to detect the hand gestures 840 in a single image 715 shown in FIG. 8D in an example. The ROI pooling layer 808 purpose is to perform max pooling on inputs of nonuniform sizes to obtain fixed-size feature maps (e.g., 7×7 units).

At block 1208, the processor 932 processes the fully connected layers 810, where the softmax layer 814 uses fully connected layer 812 to predict the class of the proposed regions and the bounding box regressor 816. A softmax layer is typically the final output layer in a neural network that performs multi-class classification (for example: object recognition).

At block 1210, the processor 932 identifies objects 802 including hand gestures 840 in the image 715. The processor 932 is programmable to identify and select different classes of objects 802 in the squares 806, for example, static hand gestures 844 and moving hand gestures 848.

At block 1212, blocks 1202-1210 are repeated in order to identify additional hand gestures 840, such as additional static hand gestures 844 including letters in a sequence of images 715 forming a word(s), additional moving hand gestures 848, or additional numbers present in a sequence of hand gestures, such as to produce larger numbers. The relevant hand gestures 840 may be determined to be relevant, in one example, if they occupy a minimum portion of the image 715, such as 1/1000 of the image or greater. This limits the processing of smaller objects that are not of interest. The relevant hand gestures 840 are referred to as features. The identified hand gestures 840 are each submitted to the hand gesture to speech algorithm 956.

Blocks 1214-1224 are performed by the hand gesture to speech algorithm 956. The hand gesture to speech algorithm 956 processes the identified hand gestures 840 received from the RCNN 945 and translates them to speech that is generated by speaker 132.

At block 1214, the processor 932 parses the hand gestures 840 of the image 715 for relevant information as per user request or context. This includes identifying the objects 802 as sign language.

At block 1216, the processor 932 processes the hand gestures by comparing the identified hand gestures 840 to the set of hand gestures 842 stored in the library of hand gestures 960. The processor identifies the particular hand gesture 840 when a match is found.

At block 1218, the processor 932 performs grapheme to phoneme conversion using a lexicon or rules for unknown words. A grapheme is the smallest unit of a writing system of any given language. A phoneme is a speech sound in a given language.

At block 1220, the processor 932 calculates acoustic parameters by applying a model for duration and intonation. Duration is the amount of elapsed time between two events. Intonation is variation in spoken pitch when used, not for distinguishing words as sememes (a concept known as tone), but, rather, for a range of other functions such as indicating the attitudes and emotions of the speaker.

At block 1222, the processor 932 passes the acoustic parameters through a synthesizer to produce sounds from a phoneme string. The synthesizer is a software function executed by the processor 932.

At block 1224, the processor 932 plays speech through speaker 132 that is indicative of hand gesture(s) 840. The speech can be one or more words having suitable duration and intonation. Speech sounds for words are prerecorded, stored in memory 934 and synthesized, such that any word can be played based on the distinct breakdown of the word. Intonation and duration can be stored in memory 934 as well for specific words in the case of synthesis. The speech can also be displayed as text on display 180C and 180D of the eyewear 100/200.

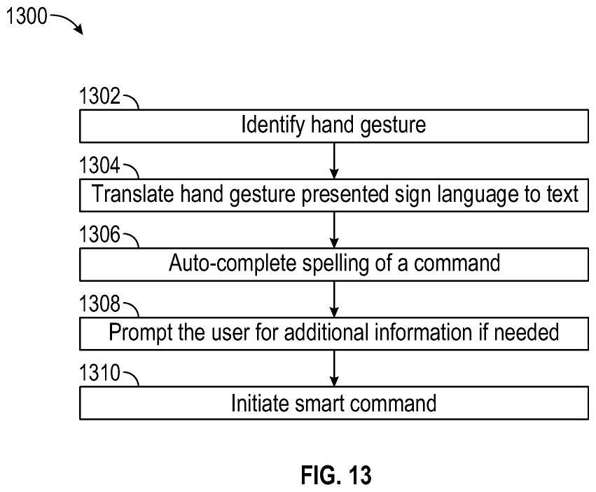

FIG. 13 is a flowchart 1300 illustrating the operation of the eyewear device 100/200 and other components of the eyewear generated by the high-speed processor 932 executing instructions stored in memory 934. FIG. 13 illustrates the sign language to text algorithm 958, auto-completion algorithm 962, and smart command utility 970 executed by processor 932 to perform translation of sign language to text to initiate a smart command, as shown and discussed with reference to FIG. 8F. Although shown as occurring serially, the blocks of FIG. 13 may be reordered or parallelized depending on the implementation

At block 1302, a hand gesture of a user presenting sign language is identified using the RCNN 945 as described with respect to FIG. 12. The hand gesture can be of a static hand gesture, of a moving hand gesture, or represents a series of letters forming a word, such as T-I-M-E-R.

At block 1304, the hand gesture presented sign language is translated to text by the sign language to text algorithm 958 as described in reference to FIG. 8F. Processor 932 may process the hand gestures by comparing the identified hand gestures 860 presenting sign language to the set of hand gestures 842 stored in the library of hand gestures 960. The processor 932 identifies a particular hand gesture, such as 860, when a match is found and converts the gesture to text. In the example of FIG. 8F, the user single spells the word “Timer” and the eyewear 100/200 displays each letter on the display as it is spelled using the sign language. Moving gestures that represent words or phrases can also be identified and converted to text.

At block 1306, the auto-completion algorithm 962 predicts the word being spelled by the user to reduce the amount of time spent by the user gesturing a word or phrase. For example, as a user signs the word “timer,” once the user has spelled ‘T’-‘I’-‘M’ using ASL, the auto-completion algorithm predicts the word “timer” and displays the word to the user as seen in FIG. 8F. In one example, the word is automatically entered once the auto-completion algorithm 962 predicts the word. In another example, the user is required to confirm the prediction of the auto-completion algorithm 962. Once the word or phrase is complete, the smart command utility 970 is initiated to perform the command that correlates to the text inputted.

At block 1308, the smart command utility 970 prompts the user for additional information as the smart command requires it. In one example, after the user inputs the command “timer,” the user is prompted to provide a duration of the timer wherein the user signs a number, such as 5 to indicate 5 minutes. In another example, after the user inputs the command “recipe,” the user is prompted to provide the name of the recipe. Certain smart commands may not require additional information wherein this step is bypassed. For example, the user may sign the command “camera” wherein the camera application of the eyewear 100/200 is opened without further input.

At block 1310, the smart command inputted is executed by the processor 932. In the example of the timer, the timer is displayed on display 180A/B with the countdown of the time remaining. In other examples, a third-party application may be launched, a message is sent, or an image is taken.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like may vary by as much as ±10% from the stated amount.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. Eyewear, comprising:
a frame configured to be worn on a head of a user;
a camera supported by the frame and configured to capture an image including a hand gesture; and
a processor configured to:
receive the image including the hand gesture from the camera;
identify the hand gesture as presenting sign language; and
generate a command that is indicative of the identified hand gesture.

2. The eyewear of claim 1, wherein the processor is configured to use a convolutional neural network (CNN) to identify the hand gesture.

3. The eyewear of claim 1, wherein the processor is configured to identify the hand gesture by matching the hand gesture in the image to a set of hand gestures.

4. The eyewear of claim 1, wherein the command is configured to initiate a predefined function.

5. The eyewear of claim 4, wherein the predefined function is setting a timer.

6. The eyewear of claim 4, wherein the predefined function is capturing an image.

7. The eyewear of claim 1, wherein the processor is configured to identify a word from a series of hand gestures.

8. The eyewear of claim 7, wherein the processor is further configured to auto-complete spelling of the word.

9. The eyewear of claim 1, wherein the hand gesture comprises a moving hand gesture.

10. A method of use of eyewear having a frame configured to be worn on a head of a user, a camera supported by the frame and configured to generate an image including a hand gesture, and a processor, the processor:
receiving the image including the hand gesture from the camera;
identifying the hand gesture as presenting sign language; and
generating a command that is indicative of the identified hand gesture.

11. The method of claim 10, wherein the processor uses a convolutional neural network (CNN) to identify the hand gesture.

12. The method of claim 10, wherein the processor identifies the hand gesture by matching the hand gesture in the image to a set of hand gestures.

13. The method of claim 10, wherein the command initiates a predefined function.

14. The method of claim 13, wherein the predefined function is setting a timer.

15. The method of claim 13, wherein the predefined function is capturing an image.

16. The method of claim 10, wherein the method further comprising the processor:
identifying a word from a series of hand gestures, wherein the processor auto-completes spelling of the word.

17. The method of claim 10, wherein the hand gesture comprises a moving hand gesture.

18. A non-transitory computer-readable medium storing program code which, when executed by a processor of eyewear having a frame configured to be worn on a head of a user, a camera supported by the frame and configured to generate an image including a hand gesture, is operative to cause the processor to perform the steps of:
receiving the image including the hand gesture from the camera;
identifying the hand gesture as presenting sign language; and
generating a command that is indicative of the identified hand gesture.

19. The non-transitory computer-readable medium of claim 18, wherein the command initiates a predefined function.

20. The non-transitory computer-readable medium of claim 18, wherein the code is operative to cause the processor to perform the step of:
identifying a word from a series of hand gestures, and auto-completing spelling of the word.
